(19) United States
(12) Patent Application Publication
(10) Pub. No.: US 2002/0026370 A1
(43) Pub. Date: Feb. 28, 2002

(54) Communication system and method for handling customer advice requirements

(75) Inventor: Martin Tasler, Erlangen (DE)

Correspondence Address: LYON & LYON LLP, 633 WEST FIFTH STREET, SUITE 4700, LOS ANGELES, CA, 90071, US

(73) Assignee: Siemens AG

(21) Appl. No.: 09/791,658

(22) Filed: Feb. 26, 2001

(30) Foreign Application Priority Data
Aug. 23, 2000 (DE) 100 41 336.6

(51) Int. Cl. G06F 17/60

(52) U.S. Cl. 705/26

(57) ABSTRACT

A communication system and method wherein a central unit stores at least one offer page that can be retrieved by a customer communication unit, wherein when the offer page indicates an advice requirement relating to the offer, the communication system reports the advice requirement in real time to the supplier communication unit, which responds to the customer communication unit in real time.

### BACKGROUND OF THE INVENTION

1. Field of the Invention

The invention relates to a communication system having at least one central unit and at least one supplier communication unit capable of communicating with a customer communication unit, and a method for operating such a system.

2. Related Art

A computer which can be linked to the Internet in an appropriate manner can be used to retrieve offer pages from a wide variety of suppliers with offers relating to products and/or services, said offer pages being stored on servers. To order one of the offers, an appropriate mask is opened on the offer page retrieved and, to place the order, a delivery address and a credit card number and/or a customer number, if there is one, need to be entered in said mask. Once the aforementioned order has been sent off, an order is processed, for example an ordered product is delivered.

In addition, information relating to the offers can be retrieved from the offer page which has been retrieved. This information needs to be gathered together by the customer himself. If advice going beyond the aforementioned information is required, the customer can, on some offer pages, open an email message with the supplier as recipient and, having expressed his questions and further information requirements in writing, can send the email message. Once the email message has been received and read by the supplier, the questions are not answered until a much later time after the time at which they arose. In this regard, the customer cannot be contacted personally for individual advice at the time at which the questions arise. The above situation makes it more difficult to sell services, such as insurance, travel etc. and products which require any explanation, such as magnetic resonance appliances etc., since the customer is on his own when searching for information and making a decision.

### SUMMARY OF THE INVENTION

It is therefore an object of the present invention to provide an improved communication system of the type mentioned initially and also an improved method for operating a communication system which reduces the aforementioned disadvantages, amongst other things.

The invention provides a communication system including at least one central unit, at least one customer communication unit, and at least one supplier communication unit configured for exchanging information with one another via a network, wherein the central unit is configured to store at least one offer page containing information relating to at least one offer from a supplier, wherein the offer page can be retrieved by the customer communication unit via the network, and wherein the offer page is configured for indicating an advice requirement relating to the offer. The communication system is configured to report the advice requirement to the supplier communication unit in real time, and the customer communication unit and the supplier communication unit are configured for real time interactive exchange of information.

The invention further provides a method for operating a communication system comprising at least one central unit, at least one customer communication unit, and at least one supplier communication unit, comprising the steps of storing, on a central unit, at least one offer page containing information relating to at least one offer from a supplier, and recognizing in real time, via a supplier communication unit, that an advice requirement has been entered by a customer communication unit on a retrieved offer page, and interactively exchanging information in real time, via the supplier communication unit, with the customer communication unit.

The invention further provides a distributed system including a server and a supplier client, wherein the server is configured to store at least one offer page containing information relating to at least one offer for a product or a service, and the server is further configured to deliver the offer page to a customer client, wherein the offer page is configured to allow the customer client to indicate to the server an advice requirement relating to the offer, the supplier client is configured to receive notification from the server in real time that the customer client has indicated an advice requirement on the offer page, and the supplier client is further configured to interactively exchange information in real time with the customer client upon receipt of the notification from the server.

The fact that, when an offer page has been retrieved, a customer's individual advice requirement can be reported to a supplier online and the supplier contacts the customer immediately for the purpose of interactive exchange of information in real time allows the customer to be advised individually and personally by the supplier, and the purchasing event can be actively molded and controlled by the supplier.

### BRIEF DESCRIPTION OF THE DRAWINGS

Other advantages, features and details of the invention can be found in the illustrative embodiments of the invention which are described below with reference to the drawings, in which:

FIG. 1 shows a communication system for one embodiment,

FIG. 2 shows a retrievable offer page from a supplier for one embodiment,

FIG. 3 shows a dialog box for indicating that advice is required for one embodiment, and

FIG. 4 shows a flowchart for one embodiment.

### DETAILED DESCRIPTION OF THE INVENTION

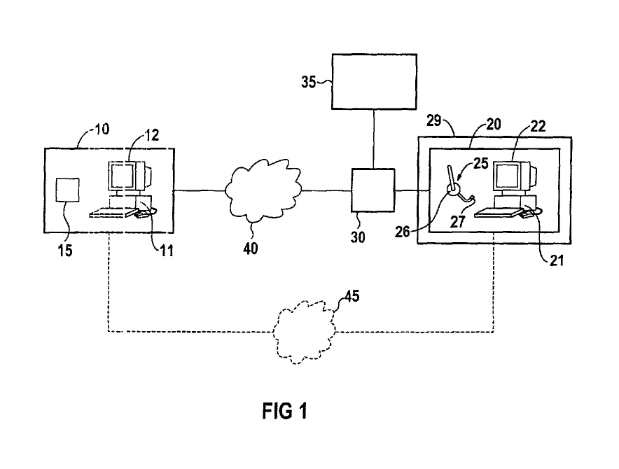

FIG. 1 shows a communication system as an illustrative embodiment of the invention. In this case, the central components which the communication system comprises are a customer communication unit 10, a central unit 30, for example a server, and a supplier communication unit 20. In this context, the customer communication unit 10 comprises a customer computer 11 with a screen apparatus 12 and also a telephone terminal 15 connected to a fixed and/or mobile telephone line. The supplier communication unit 20 comprises a supplier computer 21 with a screen apparatus 22 and also a headset 25 which is associated with the supplier computer 21, comprises at least one loudspeaker 26 and a microphone 27 and can be used to perform functions of a telephone terminal in conjunction with the supplier computer 21, amongst other things. In this case, the supplier communication unit 20 is associated with a call center 29.

In addition, the communication system comprises an order handling unit 35, an Internet facility 40 and also a telephone network 45. In this context, the customer computer 11 can be connected to the central unit 30 via the Internet facility 40. For this, the customer computer 11 can be connected to the Internet facility 40 via a public telephone network or another means of connection which permits Internet access. The telephone network 45 can be used to connect the telephone terminal 15, at least for the purposes of exchanging audio information, to the call center 29, in particular to the supplier computer 21, which, in conjunction with the headset 25, has an appropriate telephone terminal characteristic. The central unit 30 is connected to the supplier communication unit 20 and to the order handling unit 35. In this case, the latter connections can be implemented using an in-house intranet at the supplier's or in another version, for example likewise via the Internet facility 40.

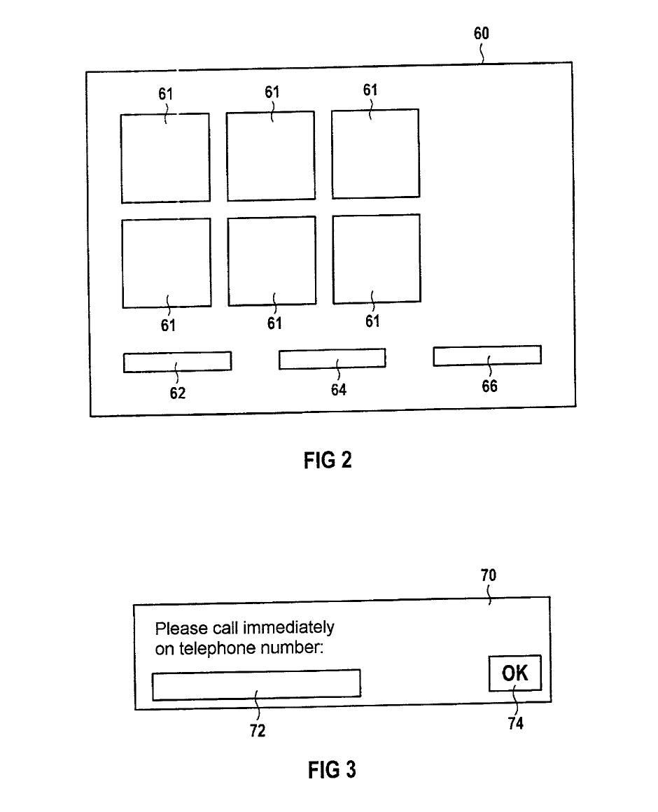

The central unit 30 can store an offer page from a supplier relating to his offers, comprising products and/or services. In this regard, FIG. 2 shows one possible design of an offer page 60 as an illustrative embodiment. Appropriate operation of the customer computer 11 by a customer permits the offer page 60 stored on the central unit 30 to be retrieved via the Internet facility 40 and displayed on the screen apparatus 12.

The offer page 60 in FIG. 2 contains buttons 61 corresponding to the offers. In one embodiment, these buttons 61 on the retrieved offer page 60 are visible as small images, each displaying the corresponding offer. The buttons 61 have appropriate references or hyperlinks associated with them which lead to other pages, which are likewise stored on the central unit 30, for example, and contain information relating to the offers. Thus, in the case of the offer page 60 displayed on the screen apparatus 12, selecting one of the buttons 61 relating to the corresponding offer permits further information to be retrieved from the central unit 30 and to be displayed on the screen apparatus 12 in an appropriate manner. In this context, one of the buttons 61 can be selected, for example, by the customer moving a mouse pointer displayed on the screen apparatus 12 onto one of the buttons 61 by moving a computer mouse associated with the customer computer 11, and accordingly selecting the chosen button 61 by pressing one of the buttons on the computer mouse.

If individual advice relating to one of the offers is required which goes beyond the aforementioned information, this advice requirement can be indicated on the retrieved offer page 60 by selecting one of the buttons 62, 64 and/or 66.

In this context, the button 62 is designed, on the basis of the prior art, such that an email message with the supplier as recipient can be opened on the retrieved offer page 60 on the screen apparatus 12 when the button 62 is selected. Questions from the customer and further information requirements can be expressed in writing in the email message and can be transmitted to the supplier by sending off the email message. Once the email message has been received and read by the supplier, the customer's questions cannot be answered until a much later time after the time at which they arose. To answer these questions, an appropriate email message, for example, can be delivered to the customer from the supplier. Interactive exchange of information in real time between customer and supplier is thus not possible.

However, in order for it to be possible to indicate directly from the retrieved offer page 60 that personal and individual advice is required in conjunction with interactive exchange of information in real time, and for this to be reported by the customer to the supplier without a time delay, the buttons 64 and 66 are provided on the offer page 60.

The button 64, to be more precise a link associated therewith, is designed such that, when the button 64 is selected to indicate that advice is required, this can be signaled in the call center 29 in real time. The indicated advice requirement can be transmitted via the Internet facility 40 and the central unit 30 in real time, for example to the supplier communication unit 20, and can be reported audibly and/or visually using the latter's loudspeaker 26 and/or the latter's screen apparatus 22. To this end, the central unit 30, which is connected to the customer computer 11 online via the Internet facility 40, recognizes that the button 64 has been selected and triggers the appropriate report on the supplier communication unit 20. A sales adviser employed by the supplier in the call center 29 then talks to the customer online via the existing Internet connection in order to settle his questions. In this regard, a chat service on the Internet facility 40 can be used, for example. In this context, the chat service permits interactive exchange of written information between the customer computer 11 and the supplier computer 21 in real time. To this end, the display on the screen apparatus 12 is split, for example, so that one half displays what is being entered on the customer computer 11, and the other half displays what is being entered on the supplier computer 21. The same applies for a display on the screen apparatus 22. If, on the other hand, there is no service point available in the call center 29 when the report is received, the customer receives an appropriate message on the customer computer 11.

Finally, the button 66 is designed such that, when the button 66 is selected, a dialog box 70 as shown in FIG. 3 can be displayed on the screen apparatus 12. In this case, the dialog box 70 contains an input field 72 for entering a telephone number for the telephone terminal 15, and also an OK button 74. In this context, the telephone number of the customer's telephone terminal 15 can be entered using a keyboard block on the customer computer 11. The OK button 74 is in this case designed such that, when the OK button 74 is selected, the advice requirement can be signaled online in the call center 29, for example on the supplier communication unit 20, including the telephone number entered. The sales adviser wearing the headset 25 and working on the supplier computer 21 in the call center 29 can then talk to the customer via the telephone network 45 and the telephone terminal 15 for the purpose of interchange of audio information for conducting an individual and personal conversation in an advisory capacity. In this context, the sales adviser's telephone call to the customer is made immediately after the advice requirement is signaled, such that the customer receives the telephone call while the customer is still at the customer computer 11 with the offer page 60 retrieved. In the case of the aforementioned telephone call, it is necessary to ensure that, when the customer computer 11 is connected to the Internet using a modem and a simple, in particular analog, telephone line, the telephone line for the telephone terminal 15 is designed so that it can be operated independently of the telephone line for the customer computer 11, in order to maintain the Internet connection and use of the telephone at the same time. To this end, the telephone terminal 15 is, by way of example, in the form of a mobile telephone with a dedicated mobile telephone line, or the customer computer 11 and the telephone terminal 15 are connected to a telephone line which has at least two channels, for example is in the form of an ISDN line.

On the basis of the illustrative embodiment portrayed, the buttons 64 and 66 are provided in addition to the button 62 which is known from the prior art. In other embodiments, the button 62 is dispensed with completely and/or the buttons 64 and 66 are combined into one button having an expanded dialog box.

Once the customer's questions have been settled, the customer can place an appropriate order for the offers with the supplier using the retrieved offer page 60. In this context, the order can be transmitted to the order handling unit 35 online via the existing connection between the customer computer 11 and the central unit 30 using the Internet facility 40 for the purpose of appropriately processing the order which has been placed.

In other embodiments, interactive exchange of audio and visual information in real time is possible simultaneously, for example. To this end, the customer communication unit 10, like the supplier communication unit 20, for example, is likewise equipped with a headset 25, and both communication units 10 and 20 are designed to be suitable for Internet telephony. In addition, the buttons 64 and/or 66 and the dialog box 70 are also of appropriate design for this purpose. In this context, depending on the fundamental software, Internet telephony permits not only voice transmission and the conventional chat service on the Internet, but also transmission of files and videos and joint drawing of an image. In one expanded refinement, the communication units 10 and 20 are also equipped with cameras, so that the functional scope of Internet telephony permits the customer and the sales adviser to see one another on the screen apparatuses 22 and 12.

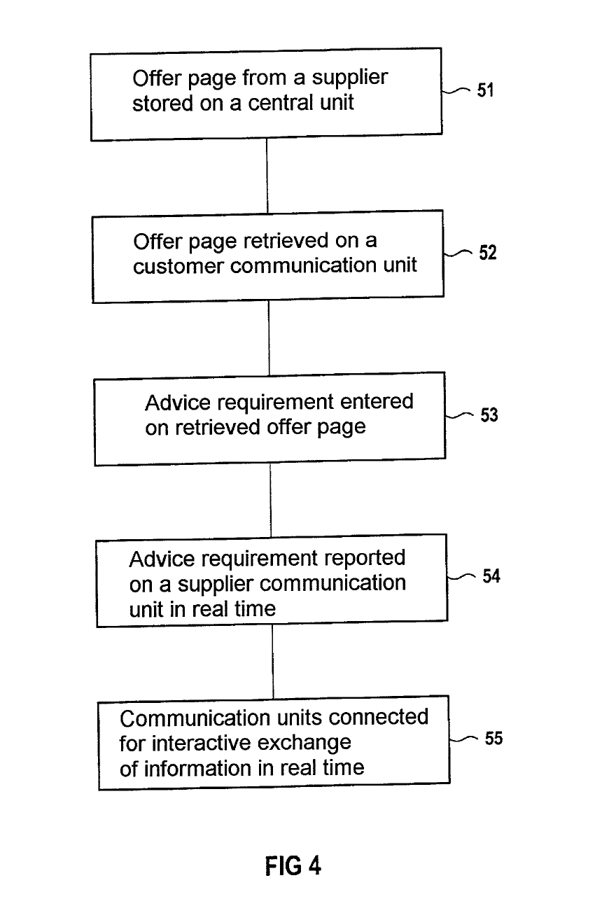

FIG. 4 shows a flowchart for a method for operating a communication system as an illustrative embodiment of the invention, where, by way of example, the communication system shown in FIG. 1 is used. In a first step 51 of the flowchart, an offer page relating to offers from a supplier, for example the offer page 60 in FIG. 2, is stored on the central unit 30 of the communication system.

In a step 52 of the flowchart, the customer uses the customer communication unit 10 to retrieve the offer page 60 stored on the central unit 30 by operating the customer computer 11 in an appropriate manner. The offer page 60 is then displayed on the screen apparatus 12. For further information relating to one of the offers, the customer selects one of the buttons 61 according to the offer in which he is interested, and the further information is then displayed on the screen apparatus 12.

Particularly in the case of complex services and/or products, the aforementioned information is not exhaustive, which means that the customer wants further, individual advice in conjunction with interactive exchange of information in real time in order to make a purchase decision. To this end, the customer indicates the aforementioned advice requirement on the retrieved offer page 60 in a step 53 of the flowchart, which follows step 52, for example by selecting the button 64.

In a step 54 of the flowchart, the advice requirement entered is reported in the call center 29, for example on the supplier communication unit 20, in real time. To this end, the central unit 30, which is connected to the customer computer 11 online via the Internet facility 40, recognizes that the button 64 has been selected and triggers the appropriate report in the call center 29.

Next, in a step 55 of the flowchart, a sales adviser employed by the supplier in the call center 29 talks to the customer online via the existing Internet connection, for example, in order to settle his questions. In this regard, a chat service on the Internet facility 40 is used, for example. In this context, the chat service permits interactive exchange of written information between the customer computer 11 and the supplier computer 21 in real time. If, on the other hand, there is no service position available in the call center 29 when the report is received, the customer receives an appropriate message.

While embodiments of the invention have been described above, many more embodiments are within the scope of the invention as set forth in the following claims.

I claim:

1. A communication system comprising at least one central unit, at least one customer communication unit, and at least one supplier communication unit configured for exchanging information with one another via a network, wherein:
the central unit is configured to store at least one offer page containing information relating to at least one offer from a supplier, wherein the offer page can be retrieved by the customer communication unit via the network and wherein the offer page is configured for indicating an advice requirement relating to the offer;
the communication system is configured to report the advice requirement to the supplier communication unit in real time; and
the customer communication unit and the supplier communication unit are configured for real time interactive exchange of information.

2. A communication system as claimed in claim 1, wherein the network comprises an Internet facility or an intranet.

3. A communication system as claimed in claim 1, wherein the customer communication unit or the supplier communication unit comprises a computer operatively coupled to a monitor.

4. A communication system as claimed in claim 3, wherein the computer is operatively coupled to a loudspeaker and a microphone, wherein the loudspeaker and microphone are optionally in the form of a headset.

5. A communication system as claimed in claim 1, wherein the customer communication unit and the supplier communication unit are configured for communicating to one another via a telephone network.

6. A communication system as claimed in claim 1, wherein the customer communication unit or the supplier communication unit comprises a fixed or mobile telephone terminal.

7. A communication system as claimed in claim 1, wherein the supplier communication unit is operatively coupled to a call center.

8. A method for operating a communication system comprising at least one central unit, at least one customer communication unit, and at least one supplier communication unit, comprising the steps of:
a) storing, on a central unit, at least one offer page containing information relating to at least one offer from a supplier;
b) recognizing in real time, via a supplier communication unit, that an advice requirement has been entered by a customer communication unit on a retrieved offer page;
c) interactively exchanging information in real time, via the supplier communication unit, with the customer communication unit.

9. A method as claimed in claim 8, wherein the information is interactively exchanged via an Internet chat service.

10. A method as claimed in claim 8, wherein the interactively exchanged information comprises video information.

11. A method as claimed in claim 8, further comprising the step of receiving, at the supplier communication unit, a telephone number entered via a customer communication unit on a retrieved offer page in conjunction with an advice requirement.

12. A method as claimed in claim 8, wherein the interactively exchanged information comprises audio information.

13. A method as claimed in claim 12, wherein the audio information is exchanged via a telephone network.

14. A method as claimed in claim 12, wherein the audio information is exchanged via an Internet facility.

15. A distributed system comprising a server and a supplier client, wherein:
the server is configured to store at least one offer page containing information relating to at least one offer for a product or a service, and the server is further configured to deliver the offer page to a customer client, wherein the offer page is configured to allow the customer client to indicate to the server an advice requirement relating to the offer;
the supplier client is configured to receive notification from the server in real time that the customer client has indicated an advice requirement on the offer page; and the supplier client is further configured to interactively exchange information in real time with the customer client upon receipt of the notification from the server.

16. A distributed system as claimed in claim 15, wherein the supplier client is operatively coupled to a call center.

17. A distributed system as claimed in claim 15, wherein the supplier client comprises a headset configured for interactively exchanging audio information in real time with the customer client.

18. A distributed system as claimed in claim 15, wherein the supplier client is configured for interactively exchanging audio information via a telephone network or via Internet telephony.

19. A distributed system as claimed in claim 15, wherein the supplier client is configured to interactively exchange video information in real time with the customer client.

20. A distributed system as claimed in claim 15, wherein the supplier client is configured to interactively exchange information in real time with the customer client via an Internet chat service.
